(19) United States
(12) Patent Application Publication
(10) Pub. No.: US 2026/0269767 A1
(43) Pub. Date: Sep. 10, 2026

(54) AMUSEMENT FACILITY WITH REGENERATIVE ENERGY SUPPLY

(71) Applicant: INDRIVETEC AG, Zürich (CH)

(72) Inventors: Martin VINZENS, Zürich (CH); Eric JULEN, Zürich (CH)

(73) Assignee: INDRIVETEC AG, Zürich (CH)

(21) Appl. No.: 18/995,583

(22) PCT Filed: Aug. 9, 2022
(86) PCT No.: PCT/EP2022/072383

§ 371 Date: Jan. 16, 2025

(51) Int. Cl. H02S 10/12; A63G 7/00; H02S 20/30

(52) U.S. Cl. CPC H02S 10/12; A63G 7/00; H02S 20/30

(57) ABSTRACT

An amusement facility with a rail system and vehicles guided on the rail system includes a drive for powering the vehicles, as well as a power supply for the drive. The rail system includes elevated sections that are arranged vertically above a base area on a support structure, on which the amusement facility is built. A plurality of photovoltaic units and/or wind energy units for generating electrical energy are arranged on the supporting structure, which are connected to at least one energy storage system for storing the generated electrical energy. The at least one energy storage system is connected to supply electrical energy to the drive and/or a control unit for controlling the amusement facility.

### TECHNICAL FIELD

The present invention falls within the technical field of amusement facilities with a guide rail system and vehicles guided on the guide rail system according to the preamble of claim 1, in particular the present invention relates to roller coasters and comparable rides.

### STATE OF THE ART, TECHNOLOGICAL BACKGROUND OF THE INVENTION

Various amusement systems, such as roller coasters and similar rides, are known from the prior state of the art, in which vehicles for carrying passengers are guided on a rail system. The amusement facilities, or the ride rail systems, are built on a base area, such as a parking lot, a leisure area or similar, with the aid of a support structure. The track system of the amusement facility is typically designed as a three-dimensional system, featuring sections that run horizontally along the base surface and elevated sections above the base surface, and this allows the vehicles to move in various directions along the base surface as well as lift off from the base surface. Furthermore, the movement of the vehicles along the rail system can also be overlaid with additional types of movement, such as rotation or swinging.

The movement of the vehicles along the rail system is powered by suitable drives, such as hydraulic drives, flywheel drives, and pneumatic drives. Due to their lower energy consumption, electric drives are becoming increasingly popular. In particular, the use of electric linear motors to drive the vehicles along the rail system offers several advantages. They are wear-free, can be operated energy-efficiently, and allow precise control of the vehicle's position and speed. Furthermore, linear motor drives enable high accelerations and speeds that are not achievable with other types of drives.

The publications EP 3311473 A1 and EP 392344 A1, for example, describe electric linear motor drive systems for amusement facilities, which are based on the induction principle and can convert electrical energy into driving and braking forces for the vehicles using stators on the rail system and magnetic rotors on the vehicles.

The known drive systems for amusement facilities are energy-intensive, as high speeds and accelerations need to be achieved. Steep sections on roller coasters, in particular, are subject to high energy consumption to lift the vehicles to the desired height on the track system. Additionally, the power supply at amusement facility locations is often limited, as these facilities are typically set up and operated in open spaces, distant from developed infrastructure. Furthermore, most of the operating electricity comes from non-renewable resources that cannot be converted into electricity without CO2 emissions.

### DESCRIPTION OF THE INVENTION

The objective of the present invention is to further develop an amusement facility in such a way that its energy supply is simplified and made more reliable, the environmental impact of its operation is reduced, and its operating costs are minimized.

The objective underlying this invention for an amusement facility is achieved through the features of claim 1. Features that further develop the inventive concept are the subject of the dependent claims.

An amusement facility with a track system and vehicles guided along the track system according to the present invention includes a drive for powering the vehicles and a power supply for the drive. The track system includes elevated sections that are vertically raised above a base surface on which the amusement facility is built, supported by a support structure. According to the invention, a number of photovoltaic units and/or wind energy units for generating electrical energy are arranged on the support structure, which are connected to at least one energy storage for storing the electrical energy. The at least one energy store is connected to the drive and/or the control unit for controlling the amusement facility to supply the drive and/or the control unit with electrical energy.

In summary, the design of the amusement facility, with a support structure for creating vertically elevated sections of the track system, is integrated into and advantageously utilized in the facility's energy supply concept. The support structure, which supports the elevated sections, creates a usable space between the base surface and the track system, which is used for positioning units that generate renewable energy, such as photovoltaic units and/or wind energy units, which are utilized for generating electrical energy. The usable space is preferably vertically oriented, with supporting elements of the support structure running, for example, perpendicular to the base surface and, thus, the energy generation units, such as photovoltaic units and/or wind energy units, can be positioned vertically on top of each other. The area surrounding the support structure in the elevated sections of the track system is usually closed to the public for safety reasons, meaning the support structure typically remains unused for additional functions. These areas and sections in the amusement facility are made accessible for additional use, according to the invention. The energy generation units support an off-grid power supply based on renewable energy, thereby improving the environmental balance of the amusement facility. The amusement facility is at least partially designed for self-sufficiency in terms of electrical energy and is more independent of the conventional power grid.

In one embodiment of the amusement facility according to the present invention, both the drive and the control unit for operating the amusement facility are connected to the at least one energy storage. Thus, both the drive of the amusement facility and the control of the drive and operation of the facility can be powered by self-generated energy. As an advantage, the control unit can also be used to manage the photovoltaic units.

The photovoltaic units are designed as flat, square solar panels, for example. A panel comprises a large number of solar cells and can be attached as a unit to the support structure for the guide rail system. In one embodiment of the amusement facility, panels are arranged with a gap between them to ensure that the wind surface area created by the multiple panels does not generate excessive wind forces on the support structure. Furthermore, the photovoltaic units can be installed at an angle to the vertical in order to favor an angle of incidence of the solar radiation.

Alternatively, the photovoltaic units can be designed, for example, as films with flexible solar cells. The foils can, for example, be provided on or between elements of the support structure.

Advantageously, the support structure for the guide rail system has a large number of individual support elements, each of which comprises mounting means for detachably attaching the photovoltaic units and/or wind energy units to the support elements. These energy generation units can be mounted on the individual supporting elements after the support structure has been assembled. However, it is also possible to provide photovoltaic units and/or wind energy units integrated in or on the supporting elements, so that these are provided at the same time as the support structure is built. Furthermore, the support elements advantageously each have cabling comprising an electrical cable and connections. During the assembly of the support structure by joining the support elements, the cabling can also be integrated through the connections, creating a conductor system on the structure that can be linked to the energy storage system. The support elements of the invention allow for the easy assembly and disassembly of the power generation units along with the support structure. This is especially advantageous for an amusement facility that is relocated to different locations and requires frequent setup and dismantling.

In a further embodiment of the amusement facility according to the present invention, the photovoltaic unit is composed of multiple solar cells, with a passageway provided between at least some adjacent cells. If the photovoltaic units are designed as solar panels, for example, these panels feature several passages between the individual solar cells. The passages create a wind channel, allowing wind to pass through and reducing the wind force exerted on the photovoltaic units. Especially in roller coasters that provide a large vertical area between the base and the track system for mounting photovoltaic units, the wind force generated by the photovoltaic units on the support structure must be taken into account. However, it is not necessary to provide passages between each neighboring solar cell. The number essentially depends on the size of the area of the photovoltaic units. As mentioned above, the photovoltaic units can also be arranged at a distance from each other.

In one embodiment of the amusement facility according to the invention, the elongated support elements of the support structure are equipped with mounting means for the photovoltaic and/or wind energy panels, allowing the units to be adjustably positioned relative to the support elements. For example, the photovoltaic units can be tilted using the mounting means, for example, relative to the support elements, allowing them to be oriented more horizontally or more vertically. Alternatively or additionally, the photovoltaic units can be rotated relative to the longitudinal axis of the supporting elements or rotated around them. The wind energy panels can be advantageously rotated in the direction of the wind. The panels, movably mounted on the support structure, can be adjusted for optimal orientation towards the sun and/or wind. The mounting means can, for example, be designed as swivel mechanisms or hinges. Telescopic rods can also be used to extend and retract sections of the photovoltaic unit relative to the support structure. The assembly equipment can be operated by electric motors and controlled via a control unit, for example.

In an advantageous embodiment, multiple sensors are installed on the support structure, photovoltaic units, and/or wind energy units to measure parameters related to solar radiation and/or wind effects. A control unit then adjusts the alignment of the photovoltaic units and/or wind energy units based on these measurements. The control unit can adjust the mounting means for the movable installation of the photovoltaic units and/or wind energy units, ensuring they are positioned optimally on the support structure. Additional sensors can also be used to measure parameters such as humidity or pollution, which can be incorporated into the alignment of the photovoltaic units and/or wind energy panels. Furthermore, for example, the power generation of the energy generation units can be monitored.

In one embodiment of the amusement facility according to the present invention, the ride rail system forms a closed, continuous track with several vertically elevated sections. This type of track system is used, for example, in roller coasters. A circular track system offers the advantage of a space-saving design while also allowing for an increased number of photovoltaic units to be installed on the site.

Additionally, the track system can at least partially enclose areas of the base surface. These areas are generally horizontally oriented and fenced off from public access for safety reasons. Advantageously, these areas can be used to install a variety of renewable energy generation units, such as photovoltaic units and/or wind energy panels, to generate electrical energy, which are also connected to the energy storage system. These units can also be equipped with sensors to measure parameters related to solar radiation and/or wind impact, and be connected to the control unit for adjusting their alignment. These additional renewable energy generation units contribute to an autonomous energy supply and help reduce the load on local power grids.

In a further embodiment of the amusement facility, according to the present invention, the drive is an electromagnetic linear motor featuring multiple magnetic rotors and stators that interact to propel the vehicles. The drive is preferably designed as a linear synchronous motor. Electromagnetic linear drives consume less energy compared to hydraulic or pneumatic systems, increasing the proportion of regenerative energy generated by the amusement facility relative to its overall consumption, thereby reducing its environmental impact.

In one variant, the magnetic rotors are incorporated into the amusement facility vehicles, while the stators are integrated into the rail system. The stators can therefore be connected directly or indirectly to the energy storage system via inverters and supplied with energy. The magnetic rotors interact with the stators to generate a driving force for the vehicles. An induction generator is advantageously installed on at least one vehicle, designed to feed the generated electrical energy back into the energy storage system. The induction generator is, for example, installed on the downward sections of the rail system, which are designed for the vehicles' downward travel. The induction generator can also be connected to eddy current brakes, with passive eddy current brakes being preferred for safety reasons. According to the invention, multiple independent energy supply pathways are possible, allowing for optimized energy generation and reduced consumption.

Thus, in addition to the energy generated by the photovoltaic and/or wind energy units, the induction generator also harvests energy, which is then available for the operation of the amusement facility. Preferably, the stators and magnetic rotors of the linear drive also function as components of the induction generator, or the linear drive operates as an induction generator when regenerative energy is transferred from the magnetic rotor to the stator.

Further embodiments of the amusement facility according to the invention and its associated advantages are the subject of the figure and its detailed description.

### BRIEF DESCRIPTION OF THE FIGURE

The invention will be explained by way of example with reference to FIG. 1 below. It should be noted that the figure does not limit the present subject matter of the invention as such, but merely shows an exemplary embodiment of the inventive concept as it is presented in the claims.

FIG. 1 provides a schematic illustration of an amusement facility according to the present invention, featuring photovoltaic units as energy generation units.

FIG. 1 features excerpts of individual units of an amusement facility according to the invention. The upper part of FIG. 1 schematically depicts structural units that represent the design of the system. A track system 7 is mounted on a support structure composed of several elongated support elements 10. The support elements 10 are positioned essentially vertically on a base surface 11 on which the amusement facility is built. On the track system 7, a vehicle 12 is shown by way of example, which may consist of several individual cars. FIG. 1 features two elevated sections 13 of the track system 7, which are arranged vertically above the base surface 11 using the support elements 10 of the support structure. A large number of photovoltaic units 8 are attached to the supporting elements 10 of the support structure. The photovoltaic units 8 are arranged on both sides of the support elements 10, stacked on top of each other, by way of example. In principle, the photovoltaic units 8 can also be arranged between two support elements 10 and mounted on opposite sides of them.

Advantageously, the photovoltaic units 8 are detachably attached to the support elements 10 using mounting means (not shown), allowing the photovoltaic units 8 to pivot around the support elements 10. Mounting arms (not shown) can also extend horizontally from the support elements 10, around which the photovoltaic units 8 are pivotably arranged along a substantially horizontal axis. The mounting means and mounting arms can be considered as positioning aids for aligning the photovoltaic units 8 relative to the support structure or the base surface 11. With the positioning aids, the photovoltaic units 8 can be optimally aligned to the solar radiation and thus maximize energy generation.

The individual photovoltaic units 8 are connected to cabling (not shown), which runs along the support elements 10 to the base surface 11. The cabling preferably includes electrical conductors on the photovoltaic units 8 to collect the electricity generated in one of the photovoltaic units 8, and a main line running along each support element to the base surface. The electrical conductors of the photovoltaic units 8 are connected to the main line by means of electrical connections. Thus, the electrical conductors of the photovoltaic units, the main line and the electrical connections form the cabling for the photovoltaic units 8.

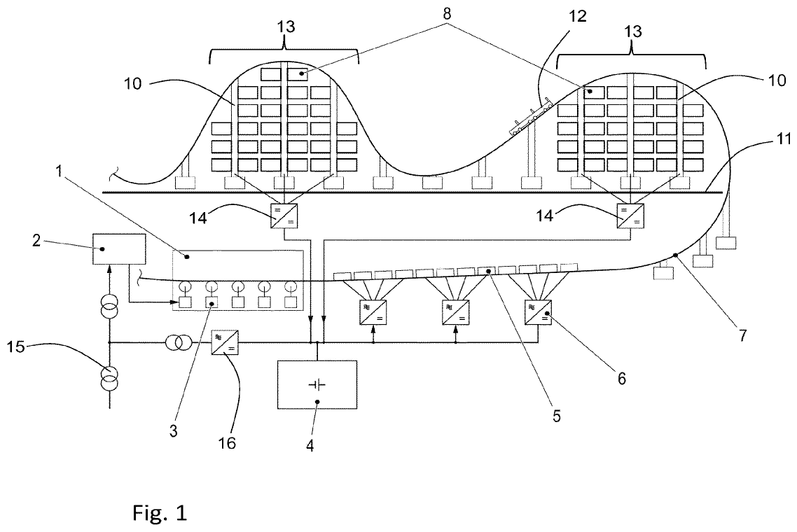

The lower part of FIG. 1 presents schematic diagrams of the energy supply, power generation units, and a drive of the amusement facility, illustrating the energy and drive concepts of the amusement facility.

The amusement facility features a linear synchronous drive. For this purpose, the track system 7 is equipped with multiple stators 4 along the tracks, while the vehicle 12 is fitted with multiple magnetic rotors 9, which generate driving force for the vehicles through induction. A possible variant of such a drive is described, for example, in the patent document EP 3 923 444 A1 of the applicant. The details described therein regarding the design of the linear synchronous drive for the amusement facility are incorporated into the description of the present invention. In principle, however, it cannot be excluded that the vehicles of the amusement facility could be powered by a different type of electric drive.

As shown in FIG. 1, the energy concept of the amusement facility includes an energy storage system 4, specifically a battery. Alternatively, energy storage could also be provided using supercapacitors or flywheel energy storage systems. The photovoltaic units 8 on a raised section 13 of the track system 7 form a group and are connected to an inverter 14 via the cabling. An inverter 14 is provided for each raised section 13 in the featured variant. Multiple inverters may also be provided, depending on the number and spatial extent of the photovoltaic units. The inverters 14 are connected upstream of the energy storage unit 4, feeding the solar power generated by the photovoltaic units 8 into the energy storage system 4. It is advantageous for the power to be fed into the system at the DC voltage level. A DC/DC converter with Maximum Power Point Tracking (MPPT) is preferred. In contrast, conventional solar inverters feed power into the system via alternating current (AC).

The stators 5 of the linear drive are supplied with regeneratively generated electrical energy from the energy storage system to drive the vehicles 12 of the amusement facility. For this purpose, multiple stators 5 can be grouped into a stator group and connected to a power supply unit 6, which is fed by the energy storage system. For example, power supply units such as feed-in converters, like rectifiers 16 or bidirectional grid inverters, can be used.

The energy concept of the featured embodiment of the amusement system also includes a connection to the local power supply network, such as the public three-phase network. Such a connection is optional in the sense of the invention. It can, for example, serve to supplement the power supply from the energy storage system or take over the energy supply for the amusement facility in areas where solar radiation is insufficient to ensure the operation of the facility. In the illustrated embodiment, the local power supply network is connected to the energy storage system 4 via a transformer 15. Thus, it can also be charged via the local power supply network.

The amusement facility also includes a central control unit 2, which controls the operation of the facility, in particular, the linear drive. It is advantageous for control unit 2 to also be connected to photovoltaic units 8 and to control the orientation of the photovoltaic units 8 by means of the assembly and the supply of solar energy to the energy storage 4. The control unit 2 is also supplied with electricity from the energy storage unit. It is advantageous for control unit 2 to also be connected to the local power supply network as a backup.

The control unit 2 controls the operation of the amusement facility, in particular, the acceleration and deceleration of the vehicles 12 by means of the linear drive. Additionally, the control unit 2 regulates a friction roller unit 3, which is designed to control the speed of the vehicles 12. The friction roller unit 3 is located in a station 1 for boarding and disembarking passengers from the vehicles 12.

Although the invention has been explained using the figure and the associated description, this representation is to be understood as illustrative and exemplary, and not as a limitation of the invention. To avoid overemphasizing the invention, well-known structures and techniques, such as the operation of the electric synchronous drive or the functioning of solar panels, are not shown and described in detail. It is understood that those skilled in the art may perform modifications and variations without deviating from the scope of the following claims.

The invention has been described with reference to FIG. 1, using photovoltaic units as examples of renewable energy generation units. Similarly, units for energy generation based on wind power can also be used. The retransmission of energy, energy storage, energy feedback, etc., can be implemented in the same way as with the photovoltaic units.

### LIST OF REFERENCE NUMERALS

1 Station
2 Control unit
3 Friction roller unit
4 Energy storage
5 Stators
6 Energy supply unit
7 Guide rail system
8 Photovoltaic units
9 Magnetic rotors
10 Support elements
11 Base area
12 Vehicle
13 Raised section
14 Inverter
15 Transformer
16 Rectifier

1-16. (canceled)

17. An amusement facility comprising:
a rail system and vehicles guided along the rail system, a drive configured to propel the vehicles, and a power supply configured to supply the drive,
wherein the rail system comprises elevated sections arranged vertically above a base surface on which the amusement facility is built,
wherein a support structure forms a usable area in a region of the elevated sections between the base surface and the rail system,
wherein a plurality of photovoltaic units and/or wind energy units configured to generate electrical energy are arranged on or between support elements of the support structure in the region of the usable area, which are connected to at least one energy storage unit configured to store the electrical energy,
wherein the at least one energy storage unit and/or a first control unit configured to control the amusement facility with electrical energy is connected to the drive and/or the first control unit.

18. The amusement facility according to claim 17, wherein the photovoltaic units are arranged at a distance from one another.

19. The amusement facility according to claim 17, wherein one of the photovoltaic units is constructed from a plurality of solar cells, wherein a passage is provided between at least some of the solar cells that are adjacent.

20. The amusement facility according to claim 17, wherein the wind energy units are wind wheels.

21. The amusement facility according to claim 17, wherein the support structure comprises a plurality of elongate supporting elements, each of which includes a mounting means for detachably mounting photovoltaic units and/or wind energy units, and/or a cabling system for forming a line system on the support structure.

22. The amusement facility according to claim 17, wherein the support structure comprises a plurality of elongate supporting elements with mounting means for the photovoltaic units and/or wind energy units, such that the units are arranged to be movable relative to the supporting elements.

23. The amusement facility according to claim 22, wherein the support structure and/or the photovoltaic units and/or the wind energy units are equipped with sensors for measuring parameters related to solar radiation and/or wind influence, and a second control unit configured to control an orientation of the photovoltaic units and/or the wind energy units based on solar radiation and/or wind influence.

24. The amusement facility according to claim 17, wherein the ride rail system forms a closed, circulating rail system with several vertically raised sections.

25. The amusement facility according to claim 17, wherein the rail system at least partially encloses surface areas of the base area, and a plurality of photovoltaic units and/or wind energy units for generating electrical energy are arranged on the surface areas.

26. The amusement facility according to claim 17, wherein the drive is an electromagnetic linear drive with a plurality of magnetic rotors and a plurality of stators, which interact to drive the vehicles.

27. The amusement facility according to claim 26, wherein the drive is a linear synchronous motor.

28. The amusement facility according to claim 26, wherein the plurality of magnetic rotors is formed on the vehicles of the amusement facility and the plurality of stators are formed on the rail system.

29. The amusement facility according to claim 17, wherein at least one vehicle is equipped with an induction generator, which is configured to feed generated electrical energy back into the energy storage system.

30. The amusement facility according to claim 17, wherein the plurality of photovoltaic units and/or wind energy units are divided into groups of photovoltaic and/or wind energy units, with each group being associated with at least one inverter that is connected upstream of the energy storage system.

31. The amusement facility according to claim 17, further comprising an electric linear drive with several groups of stators, which are arranged on the rail system to interact with the magnetic rotors of the electric linear drive located on the vehicles, and each group of stators is associated with a power supply unit connected to the energy storage system.

32. The amusement facility according to claim 17, wherein energy is supplied at the DC voltage level, wherein a DC/DC converter featuring Maximum Power Point Tracking is used.
